(19) United States
(12) Patent Application Publication
(10) Pub. No.: US 2015/0342131 A1
(43) Pub. Date: Dec. 3, 2015

(54) UNREELING HOOK FOR TYING PLANTS

(71) Applicant: A RAYMOND ET CIE, Genoble (FR)

(72) Inventors: Josep TORRES CARPIO, Barcelona (ES); Miquel MASSAGUER AGULLO, Barcelona (ES)

(21) Appl. No.: 14/723,707

(22) Filed: May 28, 2015

(30) Foreign Application Priority Data
May 28, 2014 (FR) 1454861

(51) Int. Cl. A01G 17/04

(52) U.S. Cl. CPC A01G 17/04

(57) ABSTRACT

An unreeling hook for string for training a climbing plant, said unreeling hook comprising a hook (C) designed to be hooked onto a support cable and an unreeling reel designed to receive a hank of string, said unreeling hook being characterized in that said hook and said unreeling reel are arranged in such a manner that, by hooking said hook onto said cable, said cable expels said hank of string from said unreeling reel.

### CROSS-REFERENCE TO RELATED APPLICATIONS

This application claims benefit of French patent application number 1454861, filed May 28, 2014, which is herein incorporated by reference.

### FIELD OF THE INVENTION

The invention relates to an unreeling hook for training a climbing plant.

The invention applies more particularly to growing tomato plants in a greenhouse.

[symbol] .

### BACKGROUND OF THE INVENTION

### Description of the Related Art

Inside the greenhouse, each tomato plant is trained by a string that can be left hanging vertically. That string is held up on a horizontal cable that extends parallel to the row to which the tomato plant in question belongs.

At the top, the string is wound around a reel hooked onto the above-mentioned support cable.

That reel, which can also be referred to as a “tomato hook”, is conventionally made of folded wire, extending in a plane (flat reel).

At the beginning of the season, the string is vertical, with the tomato hook above the young plant. During the season, the plant grows progressively, and fructification takes place from the bottom upwards, in successive bunches or “clusters”.

In order to increase the production of fruit on any one plant, it is desired to increase the length of the string while the plant is growing.

To obtain this result, the tomato hook is moved progressively and periodically along the horizontal support cable, and, from the tomato hook, a certain length of string is unreeled to “give some slack”, and to allow the plant to tilt.

This operation is performed by people perched on trolleys moving along the row of plants; they manipulate the hooks one-by-one, causing them to rotate so as to unreel the desired lengths of string, and moving them one-by-one along the support cable into positions that are slightly offset (along the length of the support cable) relative to their initial positions, so as to give the string the desired length and the desired curvature.

In general, the support cable on which the tomato hooks are hooked is situated at a height of about 3 meters (m) above the ground. The length of the string is about 7 m, corresponding to having about 4 min reserve, which is sufficient for a season.

At the start of the season, it is necessary to hook a tomato hook on the support cable vertically above each young plant.

The hooks as delivered by the manufacturers are already equipped with string.

During this hooking-on, the operator, perched on a trolley, allows the desired initial length of string to “run” free, that length depending on the height of the hooking support cable, which height is, itself, a function of the height of the greenhouse, and is, for example, 3 m.

For that purpose, the operator rotates the hook several times for the purpose of unreeling the correct length, with the hook acting as a reel. To this end, the operator counts each half-turn through which the hook is turned while running out the string. Thus, if the reeling length is 16.5 centimeters (cm), the operator needs to turn the hook through 18 half-turns.

It can be understood that that operation is lengthy and very tedious, in particular since it is repetitive, because the greenhouse can contain a very large number of tomato plants. That operation is also a source of errors.

Patent FR-2 779 906 proposes a tomato hook of the above-described type that, while being inexpensive, has a pre-reeled length of string wound in the form of a hank on a first unreeling reel and corresponding to the desired initial length, which length is totally separate from the remainder of the string that is wound in the form of a hank on a second unreeling reel, and it is therefore possible to unreel the initial length automatically, without any calculation being required and without any risk of error.

Thus, the manufacturer supplies tomato hooks that are each equipped with two hanks of string so that the length of string that can be taken firstly from the first hank corresponds to the desired initial length as delivered (as a function of the greenhouse), e.g. 3 m.

But before hooking the tomato hook onto the support cable, the operator still needs to unreel the necessary length of string from the first unreeling reel, constituting an operation in addition to the operation of hooking the hook onto the support cable. For example, the operator releases that first segment of string by pulling it off the first unreeling reel on the tomato hook.

The hooking-on and unreeling operations are thus performed in two distinct steps that are lengthy, arduous, and can be tedious, and an object of the present invention is to simplify them.

### SUMMARY OF THE INVENTION

The basic idea of the invention is to perform the operations of hooking-on and of unreeling the first segment of string in a single step.

The invention therefore provides an unreeling hook for string for training a climbing plant, the unreeling hook comprising a hook designed to be hooked onto a support cable and an unreeling reel designed to receive a hank of string, the unreeling hook being characterized in that the hook and the unreeling reel are arranged in such a manner that, by hooking the hook onto the cable, the cable expels the hank of string from the unreeling reel.

The unreeling hook of the invention may have the following features:
it may have two hooks disposed at respective ends of the unreeling reel in such a manner that, by hooking either of the two hooks onto the cable, the cable is caused to expel said hank of string from said unreeling reel;
the hook may have a first groove in which the cable engages, and the unreeling reel may be provided with a second groove in which the hank of string is wound, the first groove extending substantially transversely to the second groove;
the unreeling hook may be formed by folding a wire; and
it may have a first unreeling reel designed to receive a first hank of string and a second unreeling reel designed to receive a second hank of string.

The invention also provides a tying device for tomato-growing, which tying device includes an unreeling hook as described above.

### BRIEF DESCRIPTION OF THE DRAWINGS

The present invention can be better understood and other advantages appear on reading the following detailed description of an embodiment given by way of non-limiting example and with reference to the accompanying drawings, in which:

FIG. 1 is a diagrammatic view of an unreeling hook of the invention.

FIG. 2 is diagrammatically shows the unreeling hook as equipped with two hanks of string.

FIG. 3 shows the action of the support cable on the hank of string for expelling it from the unreeling reel.

FIG. 4 shows a variant embodiment of the unreeling hook shown in FIG. 1.

FIG. 5 shows devices for tying tomato plants.

### DETAILED DESCRIPTION

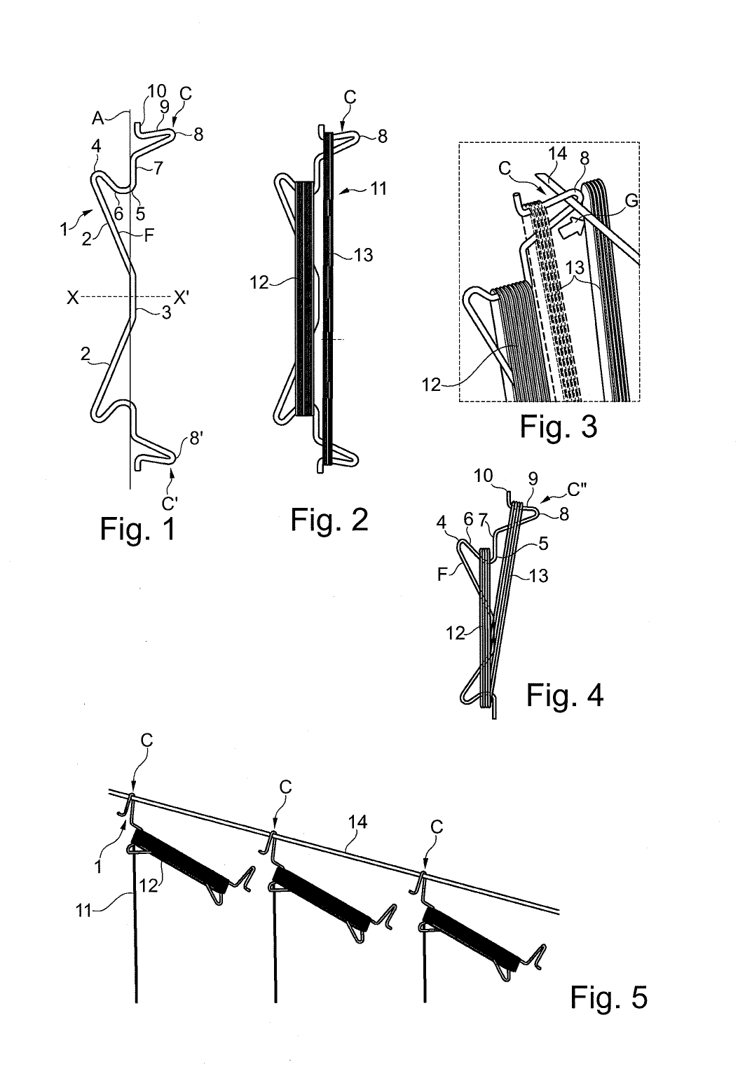

An unreeling hook of the invention for string for training a climbing plant is shown in FIG. 1 under reference 1.

It is an unreeling hook that is formed by folding a wire F, and that has a certain amount of mechanical strength and a certain amount of flexibility.

It extends along a longitudinal axis A and is symmetrical about the middle transverse axis XX′. The folding plane extends, in this example, along the axes A and XX′.

It is provided with two hooks at opposite ones of its ends along the axis A, which hooks are designed to be hooked onto a support cable 14 shown in FIG. 5.

The unreeling hook of the invention that is shown in FIGS. 1 to 5 may be equipped with two hanks 12, 13 of training string, as shown, in particular, in FIG. 2. Reference 11 in FIG. 2 designates the training string that may be several meters in length.

As shown in FIG. 1, the unreeling hook 1 has a rectilinear middle body 3 that is perpendicular to the axis XX′ and from which two branches 2 extend symmetrically over first portions of length, initially on the axis A in opposite directions.

Each branch 2 has a second portion of length that extends the first portion of length and that is inclined relative to the axis A towards the outside (towards the left in FIG. 1) of the unreeling hook 1.

The inclined second portion of length is then extended by a first bend 4.

The first bend 4 is extended via another rectilinear section of length 6 by a second bend 5 that is itself extended via another rectilinear portion of length 7 by a third bend 8. The portion of length 7 extends in FIG. 1 upwards along the longitudinal axis A.

The second bend 5 defines a groove of an unreeling reel for receiving the reeled string 11 of a first hank of string, namely the hank of string 12 in FIG. 2. The portion of length 7 that is vertical in FIG. 1 serves as an abutment for holding the first hank in collaboration with the portion of length 6 of the wire F.

The portion of length 7 is thus extended by a third bend 8 that is a sharp bend and that constitutes a hook C designed to be hooked onto the cable 14.

As shown in FIG. 1, the portion of length of wire 9 that closes the top of the hook C extends transversely to the longitudinal axis A and has a curved-back end 10 that is curved back along the axis A to define another groove of an unreeling reel for receiving the reeled string 11 of a second hank of string, namely the hank 13 in FIG. 2. This end 10 serves as an abutment for holding the second hank in the second unreeling reel.

By their design, the branches 2 are sufficiently flexible to have a spring function. Thus, while the hank 13 is being wound, it is possible to adjust the tension of the string of the hank 13 in order to ensure that the hank is held securely in place in its unreeling reel. The higher the tension in said hank, the more difficult it is for the end of the hank to be removed from the bend 8.

By way of indication, the length between the ends of the hook along axis A is about 200 millimeters (mm).

As is well known, the unreeling hook of the invention is equipped with two hanks 12 and 13 made of a single string 11.

As is visible in FIG. 2, the string 11 of the hank 13, which constitutes the secondary hank, is wound around a first unreeling reel formed by two grooves that are opposite from each other along the axis A, and each of which is constituted by the portion of length of the wire 9 that closes the respective hook C (and also by the curved-back end of the wire 10).

The string 11 of the main hank, which, in this example, is hank 12, and which comprises the longest length of string 11, is wound around a second unreeling reel that has two winding grooves that are opposite from each other along the axis A, each of which is constituted by a respective bend 5.

The second hank 13 of string is designed to be released from the first unreeling reel in one go, by allowing the string to run to the ground. The length of the string 11 in the hank 13 depends on the height of the hooking cable 14.

The main hank 12 of string is designed to be unreeled while the climbing plant is growing. The length of the string 1 in the main hank 12 may be considerably longer than the length of the string in the secondary hank 13. It is understood that the string 11 is reeled without any interruption between the two shanks 12 and 13.

FIG. 5 shows the unreeling hook 1 of the invention in the position in which it is hooked on the support cable 14, the string 11 of the secondary hank 13 being unreeled towards the ground.

As shown in FIG. 5, the unreeling hook 1 of the invention is held inclined and it is possible, merely by traction being applied to the string 11, for the main hank 12 to be unreeled progressively.

In accordance with the invention, and as indicated by arrow G in FIG. 3, the hook C and the second unreeling reel that receives the secondary hank 13 are arranged in such a manner that, by hooking the hook C (formed by the bend 8) on the cable 14, the cable 14 expels the hank 13 from the second unreeling reel.

More particularly, the user takes hold of the unreeling hook 1 of the invention, as equipped with the hanks 12 and 13 of string, by taking hold of it at the middle body 3, and engages the support cable 14 into the groove in the hooking hook C.

The cable 14 then exerts thrust on the loop of the secondary hank 13, as indicated by arrow G in FIG. 3, which hank is wound over the top of the hook C, this thrust causing the shank of string 13 to be expelled from its unreeling reel, the string 11 then running by itself and under gravity towards the ground.

This principle applies equally well to either of the two hooks C, C′ in FIG. 1 (which hooks are formed by respective ones of the two bends 8, 8′) that are disposed at respective ones of the two ends of the unreeling hook 1 of the invention along the axis A, so that the user does not have to think about which way round to hook the unreeling hook 1 on the support cable 14.

This thus makes it simpler and quicker to install devices for tying tomato plants in industrial greenhouses.

It can be understood that, with the unreeling hook 1 of the invention, the inclination of the groove of the hook relative to the longitudinal axis A can have an effect on the traction force to be exerted on the unreeling hook while it is being hooked onto the support cable. The closer the inclination of the groove in the hook is to being perpendicular to said axis A, the easier it is to hook it onto the cable 14 with its hank of string 13 being released.

In addition, it can be understood that the coefficient of flexibility of the unreeling hook of the invention (flexibility of the wire F, in particular) has an influence on said traction force to be exerted due to the spring effect generated when the hank of string 13 is pushed against the cable during hooking.

The elasticity of the string can also have an influence on the traction force to be exerted, although this parameter is quite negligible.

FIG. 4 shows another configuration of folding of the wire F for constituting an unreeling hook of the invention with a single hook C″. In this embodiment, the two unreeling reels have common winding grooves.

It should be understood that the unreeling hook 1 of the invention could be made by molding a plastics material, by cutting from sheet metal, or by making successive additions of materials (plastics or metal materials) such as those used for additive manufacturing or “3D printing”.

The unreeling hook 1 of the invention is well suited for growing tomatoes in greenhouses, but it could also be used for other climbing plants that require analogous training.

1. An unreeling hook for string for training a climbing plant, said unreeling hook comprising a hook (C, C′, C″) designed to be hooked onto a support cable and an unreeling reel designed to receive a hank of string, said unreeling hook being characterized in that said hook and said unreeling reel are arranged in such a manner that, by hooking said hook onto said cable, said cable is caused to expel said hank of string from said unreeling reel.

2. An unreeling hook according to claim 1, characterized in that it has two hooks (C, C′) disposed at respective ends of said unreeling reel in such a manner that, by hooking either of said two hooks onto said cable, the cable is caused to expel said hank of string from said unreeling reel.

3. An unreeling hook according to claim 1, characterized in that the or each hook has a first groove in which said cable engages, and said unreeling reel is provided with a second groove in which said hank of string is wound, said first groove extending substantially transversely to said second groove.

4. An unreeling hook according to any preceding claim claim 1, characterized in that it is formed by folding a wire.

5. An unreeling hook according to claim 1, characterized in that it has a first unreeling reel designed to receive a first hank of string and a second unreeling reel designed to receive a second hank of string.

6. A tying device for tomato-growing, said tying device being characterized in that it includes an unreeling hook according to claim 1.
